(19) United States
(12) Patent Application Publication
(10) Pub. No.: US 2010/0305961 A1
(43) Pub. Date: Dec. 2, 2010

(54) TOOLS, SYSTEM AND METHOD FOR VISUAL INTERPRETATION OF VAST MEDICAL DATA

(76) Inventor: Michael S. Broder, Beverly Hills, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/474,611

(22) Filed: May 29, 2009

(51) Int. Cl. G06Q 50/00; G06T 11/20

(52) U.S. Cl. 705/2; 345/440

(57) ABSTRACT

A graphical representation incorporating discrete patient medical history into a single-view for evaluating patterns in the data. A graphical tool comprises a series of linear segments that represent a patient history or medical data, where the segments are oriented with a time axis to show start time, stop time, and duration. Using lines of extremely thin weight and placing each patient's history immediately adjacent other patient's history, hundreds or thousands of patient data can be represented by a single view. Statistical analysis can be performed on the data to yield further information on the medical data, which can be superimposed on the graphical display.

### BACKGROUND

Medical data is often the most difficult data to evaluate for those studying the effects of various stimuli such medication, exercise, nutrition, weight gain or weight loss, etc., in a population of patients. Many factors enter into the study of human behavior and medical treatment, and the interaction of factors necessitate a large sample size to adequately assess a particular treatment or study unit. Because each patient reacts differently, and statistical theory requires many thousands of data to understand the effects of such stimuli, those tasked with interpreting the data are often left to review reams of pages of data. There are few tools for making observations about the general role that such stimuli plays in these patients, and even fewer tools for allowing a statistician to quickly understand the effects that the stimuli have on the majority of a large population of patients.

For example, when a medication is introduced into a patient population it is important to track the results of the efficacy of the medication. If a hundred thousand patients being tracked in a clinical study are subjected to the medication of interest, each patient will have an individual response to the medication that may include length of time to recovery, dosage, number of patients on the medication, number of patients who needed to be switched to a different medication, and so forth. While such information can be tabulated in a tables, the tables cannot show individual cases but rather must lump all the patients within a certain range or category into groups and then tally the groups to present the data. This necessarily obscures the individual patient's data, but there is no convenient way of representing and presenting medical data comprising hundreds of thousands of data entries in a single, easy to read and understand format.

While much of the information already exists in databases, there is no convenient method of compiling and analyzing the stored data in a graphical format that allows a user to quickly make general and individual assessments of the results of the data. That is, data may exist in administrative pharmacy claims databases or in self-reported databases. Although such information is readily available through a LAN, wireless, or wired network, the tools needed to make use of the data are not available. As a consequence the talent and training of researchers and clinicians often go untapped because they do not have ready access to a discernable display of the data from large populations of patients, expanded to different treatments over different time periods. The present invention seeks to overcome the shortcomings of the existing data evaluation tools and provides a new tool and method that allow a user to easily interpret medical data involving many patients in a quick and easy to understand format.

### SUMMARY OF THE INVENTION

The present invention involves tools such as a data compilation in the form of a graph that provides a single sheet view incorporating a high definition data representation to convey patterns of activities relating to, for example, a medical study of a large group of patients, and a system and method for generating the compilation. The system comprises a computer having a processor and a data input device, and a data output device such as a screen, printer, and the like, for creating a graphical representation of medical data for a large population of patients. The graphical representation preferably involves discrete linear segments representing individual's response to a medical condition, where the linear segments can take the form of varying colors, lengths, or other characteristics arranged to form a two dimensional graph of the results. Time is represented on a first axis of the graph, and the number of patients can be on a second axis. Every patient is represented in the graph by a discrete linear segment, preferably a single pixel in width. The data can be represented over time, with the linear segments aligned on the time axis to illustrate the duration of the patient's exposure to the stimuli, length of time to complete trial, and other parameters. From these graphs, patterns emerge that allow the practitioner to quickly make determinations on a macro level about the effectiveness of the treatment by considering large numbers of patient histories.

### BRIEF DESCRIPTION OF THE DRAWINGS

FIG. 1 is a graphical display of a small population of participants in a drug study, where the regimen before and after the drug introduction for each patent is the same.

FIG. 2 is a graphical display of a larger population of participants in the drug study of FIG. 1 where the regimen before the drug introduction is different from the regimen after the drug introduction for each patient.

FIG. 3 is a graphical display of a small population of participants in a drug study of FIG. 1 where there was no regimen for the patients prior to the introduction of the drug for each patient.

FIG. 4 is a graphical representation of a large population of patients in the drug study of FIG. 1 with various conditions after initiation of the drug.

### DETAILED DESCRIPTION OF THE PREFERRED EMBODIMENTS

The present invention is used to display via a display screen, a printer, or other means an aggregate depiction of medical data corresponding to patients undergoing a treatment. The invention is capable of displaying through a high resolution image hundreds of thousands data points representing thousands of patient histories. Using lines, segments, colors, and patterns, the user can interpret patient actions across thousands of study units without reviewing extensive numeric tables or patient files.

The human eye transmits data to the brain at ten million bits of information per second. A typical PowerPoint® slide contains forty words. A dense table may contain one hundred data points. In the present invention, hundreds of thousands of data points can be represented in a single graph. By reviewing the lines, segments, colors and patterns, a user can interpret patient reactions to treatments across thousands of study units without resort to extensive numeric tables or pages and pages of data.

The invention starts with a patient and a study of the patient's treatment, in the example given to the introduction of a drug to remedy a patient's malady. The study may consider several different factors, such as the dosage of drug X that the patient takes or the cooperation of drug X with a second drug, third drug, or combination thereof. If the patient stops taking the drug after two weeks, it can be assumed that the patient's malady was cured. However, if the patient after two weeks switches to drug Y, then this also effects the efficacy of drug X. However, to truly examine patterns in the treatment of drug X among thousands of patients, a new way of viewing data is needed.

A software program is used to draw images based on data recalled from a previously created database of patient information. For example, the database could be routinely collected administrative pharmacy claims data or patient self-reported data. The source data can be stored on or connected to computers by a local area network (LAN), wired network, or a wireless network. Moreover, statistical software for managing data such as those offered by SAS® (http://www.sas.com/index.html) can be employed on the computer to analyze and aggregate the various patient data in order to determine patterns for each study unit.

One goal of the present invention is to observe patterns in large quantities of data within a study unit by visually inspecting tens or even hundreds of thousands of data points within a single view. Here, “single view” means that the entire data can be viewed as compiled in a single graph, whether that graph is depicted on a printed sheet of paper or displayed on a computer monitor or the like. A first step in the process is to identify “episodes” within each study unit. An episode can be many different things, for example the time during with a patient takes a particular medication. Other examples can be an exercise program, a diet regimen, a rehabilitation stint, or post-operative recovery. The episode typically has a start time, an end time, and a duration. In tracking a medication the start time would be the date that the patient first is introduced to the medication, the end time would be the date the patient ceases using the medication, and the duration would be time that the patient that the patient is on the medication. The graph can employ lighter and darker shades of a single color to represent high and low dosages of the drug, and different colors to represent different drugs. For example, light green may represent a low dose of drug X, and dark green may represent a high dose of drug X. Each stint of drug X, both high and low doses, can be represented by different events with different start, finish, and duration times corresponding to different positions on the graph. Other factors could be the patient's dosage, age, gender, and other factors that could influence the efficacy of the medication, with each factor given a different identifier in the graph.

The pattern to be studied for a particular unit study is a sequence of episodes showing the respective start, end, and duration data for various episodes. Summary information containing patterns for either all study units or selected study units are then plotted on a graph and presented in the graphical format. Patterns of study units may be represented by line segments plotted on a time axis. Each segment represents an episode in the study unit, and the location and length of the segment corresponds to the chronological time of the episode. For example, episodes that occur earlier are found to the left of those occurring later on the time axis. Moreover, the length of the segment corresponds to the duration of the episode. Using different styles (dashed, variable thickness, etc.) and color of the segment can also be used to represent different types of episodes.

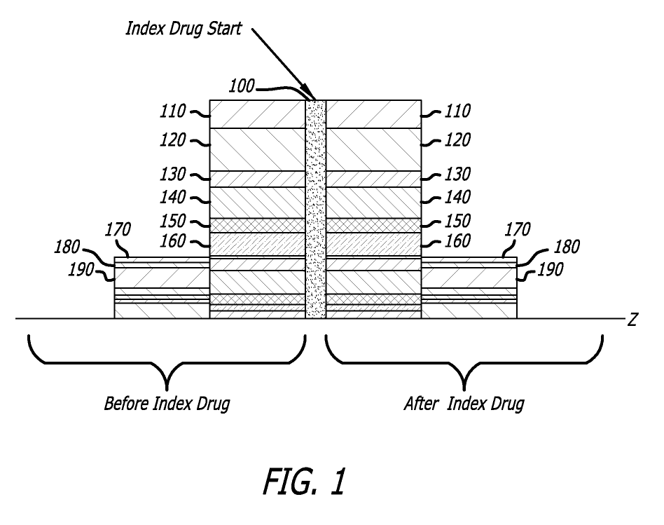

An example of the display and method for analyzing patterns in the data is provided below. The data corresponds to a study unit to evaluate patterns involving a medication to treat a particular condition. In FIG. 1, a study of a population of patients who are taking an index drug X for the first time is shown, where a vertical line 100 is drawn to a length corresponding to the number of patients. In FIG. 1, the boxes to the left and right of line 100 correspond to a particular type of secondary drug regimen, although it could also represent other factors that weigh on the recovery such as diet, exercise, etc. As shown in FIG. 1, the regimen before the introduction of the drug X for the entire population of users represented in FIG. 1 is the same as the regimen after the introduction of drug X. For example, a percentage of the population was on drug Y 110 prior to the introduction of drug X, and that same population (represented by the height of box 1 10) continued to use drug Y after introduction of drug X. Another population was on drug W 120 prior to starting drug X, and those same patients continued to be on drug W after introduction of drug X. Although the duration of taking drugs Y and W may be equal before and after the introduction of drug X, it is not necessarily so and the boxes in FIG. 1 only represent periods before and after the introduction of drug X.

In the same manner, a smaller population of the patients were on drug V 130, where the relative height of box 130 is less than the previous boxes illustrating a smaller population of patients. Yet a fourth group of patients were exposed to drug T 140 before and after the introduction of drug X. Two more groups, corresponding to boxes 150 and 160, represent patients who were taking a combination of drug Y and W (150) and drug Y and T (160), respectively. Lines 170, 180, and 190 correspond to patients who were initially exposed to a first drug or combination of drugs, and then changed to a new regimen before introduction of drug X. Those same patients, as reflected in the symmetry of FIG. 1, continued the new regimen after the introduction of drug X for a period before returning to the original drug or combination of drugs.

A quick review of FIG. 1 can yield some interesting observations. First, a graphic of the number of patients that were introduced to drug X can be seen, and the respective population of patients exposed to one remedy or another (in the form of various combinations of drugs) is readily displayed. Also, the effect of different secondary drugs on the effectiveness of drug X may be appreciated. Finally, the percentage of each secondary drugs that were used in combination with drug X can be seen from FIG. 1.

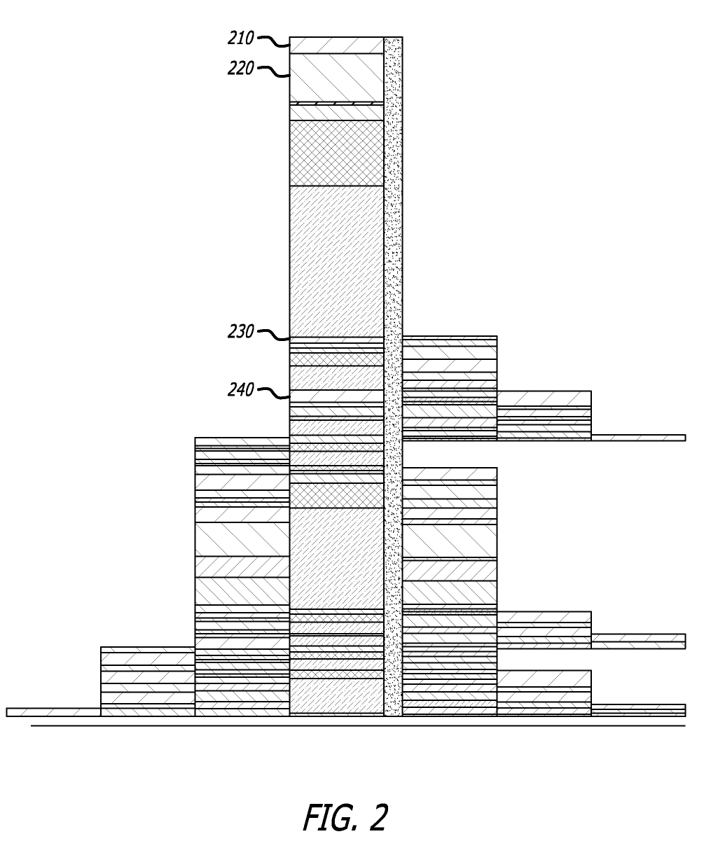

In FIG. 2, a graph is depicted representing a different set of patients that were introduced to drug X. In FIG. 2, the regimen is not symmetric, meaning that each patient reflected in FIG. 2 experienced a different regimen before the introduction of drug X than after the introduction. As with FIG. 1, the height of each box corresponds to the number of patients that it represents. For example, in box 210, drug Y was used to treat before the introduction of drug X and no drug was used after the introduction of drug X. Box 220 represents patients that used drug W before the introduction of drug X, where the number of drug W users was approximately three times the number of drug Y users. Box 230 corresponds to patients who were on drug Y before drug X, and drug W after drug X. Box 240 represents patients that were on drug Y before drug X, and then on some other drug or drugs after drug X, but then returned to drug Y. Various other combinations of are illustrated in FIG. 2, where combinations of drugs before and after drug X, including no drugs before, no drugs after, multiple episodes of drugs before and after, etc. This graph, like FIG. 1, shows in a single view the number of patients that are taking drug X and the relative percentages of the patient's various regimens before and after the introduction of the drug.

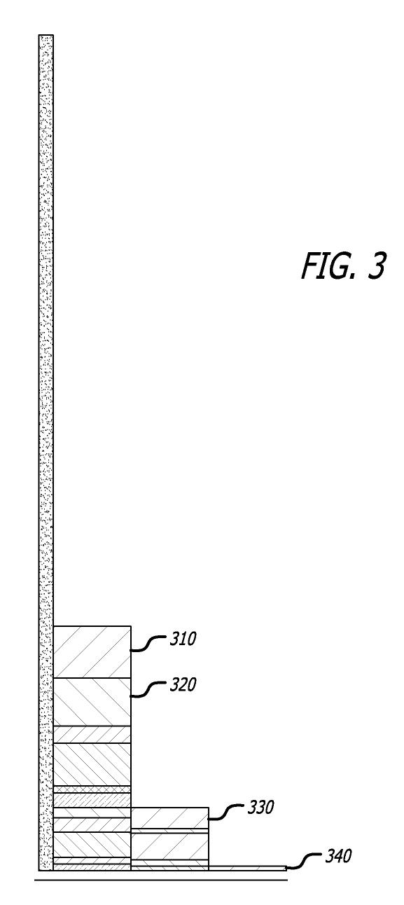

In FIG. 3, all of the patients had no prior exposure to any of the secondary drugs prior to the introduction of drug X. Box 310 corresponds to those patients who began taking drug Y after starting drug X, and box 320 represents the patients who began taking drug W after starting drug X. Box 330 corresponds to patients who took drug X in combination with another non-drug Y immediately after starting drug X, but then switched to drug Y after a certain period. Box 340 corresponds to patients who started one non-drug Y regimen, followed by another non-drug Y regimen, and then concluded with a regimen of drug Y. In each case, the height of the boxes corresponds to the relative number of patients who fall into each category.

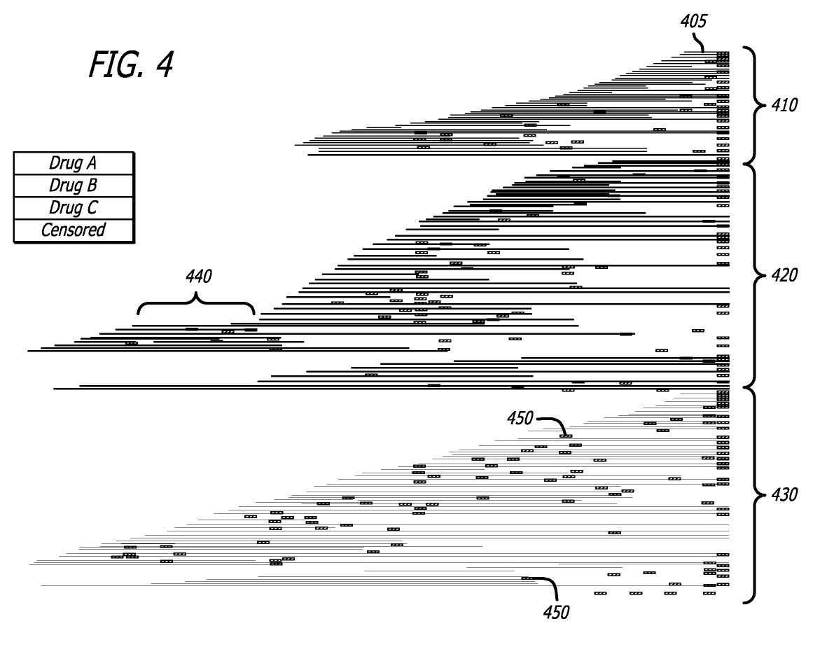

FIG. 4 depicts a tool that can be used to evaluate a multiple drugs using a large number of patients. It should be noted that limitations in the line drawings prevent a true picture of the actual graphs generated by the present invention from being represented, but that the illustration of FIG. 4 demonstrates how patterns can be visualized for large numbers of patient-data. FIG. 4 shows three drug evaluations, namely drug A 410, drug B 420, and drug C 430. Each study would normally appear as a different color on the graph corresponding to a different drug, but FIG. 4 uses line thickness to differentiate between the drugs. The graph of FIG. 4 can represent thousands of patients, where the height of each section (410, 420, 430) is proportional to the number of users of each drug. Each line 405 corresponds to a single patient's duration, start, and end of the drug use, and is preferably but not limited to a single pixel width. The length of each line 405 represents the duration of the drug use, and the position of the line corresponds to when the drug use began and ended. For example, it can be seen that the drug A 410 entered the market later than drugs B 420 and C 430, and thus the first use of drug A appears to the right of the other two drugs on the time axis. One can also see that, for example, the relatively flat region denoted 440 on the graph corresponds to a production problem that occurred in Drug B 420 during that time period, limiting the distribution of that drug. Heavy concentrations of the lines represent persistence of the drug use, and markers 450 can signify a drug switch from one drug to another. Changes in the color of the lines can represent different dosages of the drug, so the practitioner can evaluate this characteristic as well on the same graph.

The graph can also show other factors, using different colors, line thicknesses, or even a third axis, to overlay additional information. For example, hospital stay could be overlayed over the graph of FIG. 4 with another indicator, or could be plotted on a third axis to create a three dimensional graph.

The graph of FIG. 4 shows that some users remain on the drug(s) much longer than other patients, and some patients switch from one drug to a different drug over the period in question. Other factors can show how patients return to the original dosage or maintain a specific dosage, and when and how many patients switch drugs during the course of treatment. The number of patients who attempt a particular drug regimen, and the efficacy of that regimen, can also be evaluated by the thicknesses/concentrations of the lines and the relative lengths of the lines for a particular regimen.

The graph of FIG. 4 also allows a practitioner to understand patterns of drug use for a specific condition, and further allows comparisons of persistence/adherence among different drugs in a selected class. Where each patient is represented by a line a single pixel wide, thousands of patients can be represented in the graph of FIG. 4. Patterns can then be instantaneously evaluated based on actual patient data. The statistical analysis can be performed to yield certain information for the study, such as a median time from a patient's switch from one dosage to another or a percentage of patients who never switch dosages, etc., and the statistical data can be superimposed or overlayed on the graphical representation to provide further information on the medical study and supplement the visual patterns displayed by the graphical representation.

To carry out the present invention, a computer system incorporating a processor, a RAM memory, a bus, a power supply, and a display are preferably provided. The data can be loaded onto the computer system directly using a data transfer system such as magnetic disks, or by retrieving the information via a network such as a LAN, intranet, or internet. In the latter case, the processor is coupled to an internet access via a modem, ISDN, DSL line, cable, wireless connection, T1 line, and satellite connections. These systems are well known in the art, and further elaboration of these computer systems are omitted for brevity. Such systems are disclosed in U.S. Pat. No. 7,305,348 to Brown and U.S. Pat. No. 6,247,004 to Moukheibir, the contents of both of which are fully incorporated herein by reference. Patient data is preferably stored on the computer system, where statistical analysis programs such as SAS® (http://www.sas.com/index.html) can be used to perform data manipulation on the data for further study. The computer system then recalls each patient data, where the data preferably has a start time, an end time, a duration, and type associated with it. Here the “type” can refer to a drug study, or any other type of medical investigation can be performed. For example, Patient 1000 may have a medical data that includes a type (use of drug X), a start date (May 2008), an end date (May 2009), and a duration (1 year). A graphical program loaded in a read only portion of the computer system is recalled, and the data for Patient 1000 is plotted on a graph having a time axis, where Patient 1000's data is represented by a linear segment. The length of the linear segment corresponds on the time axis to one year, matching the duration of the information. The start and end dates are located appropriately on the graph, and the line segment is given an identifier to associate the line segment with the study “type.” Here, the line may be blue to show that this is a drug X patient. The computer system then retrieves Patient 1001 and performs the same set of instructions, where Patient 1001 is plotted adjacent Patient 1000. Using a high definition display, and making the line segments one pixel wide, a graph can reasonably include over a thousand patient's data on a single view graph. As shown in FIG. 4 and discussed above, patterns can be readily determined from such large numbers of patient data that cannot otherwise be determined reviewing individual case histories.

The tools, method, and system of the present invention provides a practitioner with heretofore unavailable tools to evaluate large quantities of medical data in an informative single view representation to provide a quick analysis of efficacy heretofore unavailable to researchers and clinicians. Those skilled in the art will recognize that variations from those examples discussed above will be apparent, and those variations are deemed to be within the scope of the invention. Accordingly, the examples and illustrations used herein are not to be considered limiting in any manner, but rather merely exemplary. The scope of the invention is properly deemed to be measured by the words of the appended claims, giving those words their ordinary and plain meanings, consistent with but not limited to the discussion and illustrations herein.

1. A tool for evaluating a large amount of medical data pertaining to numerous patients in a selected medical study, where a treatment of each patient is displayed graphically, the tool comprising:
a display medium for displaying a multi-axis graph, the display medium including an orthogonal axis system with a first axis corresponding to a treatment duration and a second axis corresponding to a number of patients;
a single view graphical representation displayed on the display medium comprising a series of line segments aligned with the time axis, each line segment corresponding to respective ones of the patient's medical data with each patient's medical data represented by a line segment;
the line segment having a length corresponding to a period of time that the corresponding patient's medical data was obtained; and
the graphical representation depicting the medical data via said line segments for every patient in the study.

2. The tool for evaluating a large amount of medical data of claim 1 wherein the medical study comprises a study of a drug used by the patients.

3. The tool for evaluating a large amount of medical data of claim 2 wherein the medical study includes a study of secondary drugs on an effectiveness of the drug.

4. The tool for evaluating a large amount of medical data of claim 1 wherein each line segment is a single pixel wide.

5. The tool for evaluating a large amount of medical data of claim 1 wherein the display medium is a sheet upon which a graph is printed.

6. The tool for evaluating a large amount of medical data of claim 1 wherein the display medium is a monitor screen.

7. The tool for evaluating a large amount of medical data of claim 1 wherein the line segments have different colors to represent different factors to be studied.

8. The tool for evaluating a large amount of medical data of claim 2 wherein different drugs are assigned a different color line segment.

9. The tool for evaluating a large amount of medical data of claim 8 wherein different dosages are assigned a different shade of a same color for a particular drug.

10. The tool for evaluating a large amount of medical data of claim 1 wherein statistical data on a population of patients are overlayed over the graphical representation.

11. A method for evaluating a large amount of medical data from a plurality of patients using a single image comprising the steps of”
collecting medical data on a plurality of patients and storing the collected medical data in a selected storage device;
perform statistical analysis on the stored medical data, where each patient's medical data includes a start time, an end time, and a duration;
causing each patient's medical data to be displayed on a single-view graph using a line segment having a length corresponding to the duration of the patient's medical data;
arranging each line segment in the graph so that every patient's medical data is displayed graphically by line segments unique to the respective patients; and
evaluating the graph to determine patterns from among the patient data.

12. The method for evaluating a large amount of medical data of claim 11 wherein the medical data relates to a study of the patient's reaction to a selected drug.

13. The method for evaluating a large amount of medical data of claim 11 further comprising displaying the graph using different colors to represent different medical factors.

14. The method for evaluating a large amount of medical data of claim 11 wherein data is displayed on a printed sheet.

15. The method for evaluating a large amount of medical data of claim 12 wherein a patient's dosage of the drug is reflected in by a particular characteristic of an associated unique line segment.

16. The method for evaluating a large amount of medical data of claim 12 wherein the graph is used to track more than one drug.

17. The method for evaluating a large amount of medical data of claim 16 further comprising using multiple colors for the line segments to represent different drugs.

18. The method for evaluating a large amount of medical data of claim 16 further comprising indicating on the graph where a patient has switched from one drug to another drug.

19. The method for evaluating a large amount of medical data of claim 11 further comprising overlaying statistical data over the graph to provide additional information regarding the patient history.
